(19) United States
(12) Patent Application Publication
(10) Pub. No.: US 2021/0372645 A1
(43) Pub. Date: Dec. 2, 2021

(54) MULTIPURPOSE MULTIFUNCTION DEVICE

(71) Applicant: SHPI GMBH, Panketal (DE)

(72) Inventor: Lutz Harder, Panketal (DE)

(21) Appl. No.: 17/372,488

(22) Filed: Jul. 11, 2021

Related U.S. Application Data
(63) Continuation of application No. PCT/EP2019/087176, filed on Dec. 30, 2019.

(30) Foreign Application Priority Data
Jan. 11, 2019 (DE) 20 2019 000 228.6
Jan. 11, 2019 (DE) 20 2019 000 229.4

(51) Int. Cl. F24F 11/30; F24F 11/58; F24F 11/52; F24F 11/88; F24F 11/89; H04L 12/28

(52) U.S. Cl. CPC F24F 11/30; F24F 11/58; F24F 11/52; F24F 2110/20; F24F 11/89; H04L 12/2816; H04L 2012/285; F24F 11/88

(57) ABSTRACT

A multipurpose distributed building automation device, also known as a “smart home device”, and a method for implementing a distributed building automation network are provided. The devices according to the disclosure are used for controlling devices and building services technology in the context of building automation. The device according to the disclosure has a housing and a display and comprises the following components: at least one sensor, at least one actuator and at least one computing unit, wherein the components are arranged in the housing and thus combined in one device and the device is functional without a connection to a central gateway or network device and the device is embodied for installation in a flush-mounting box or as a replacement device for a wall thermostat and has a power supply unit or voltage converter.

### CROSS-REFERENCE TO RELATED PATENT APPLICATION

This application is a continuation application of international patent application PCT/EP2019/087176, filed Dec. 30, 2019, designating the United States and claiming priority to German applications 20 2019 000 228.6 and 20 2019 000 229.4, both filed Jan. 11, 2019, and the entire content of the three applications is incorporated herein by reference.

### TECHNICAL FIELD

The disclosure relates to a multipurpose distributed building automation device, also known as a “smart home device”, and to a method for implementing a distributed building automation network. The devices according to the disclosure are used for controlling devices and building services technology in the context of building automation.

### BACKGROUND

Various building automation applications are known in the current prior art, such as networked devices for controlling lighting, heating, ventilation and air conditioning, networked meters for acquiring consumption values (water, electricity, heat, gas etc.), smart domestic appliances (televisions, loudspeakers, washing machines etc.) and sensors for detecting environmental values (temperature, brightness, air quality, air pressure, presence detection).

The current prior art makes use of numerous different devices (servers, sensors, actuators) to achieve common building automation solutions (heating control, lighting control, monitoring tasks).

Providing radio or wired networking, supplying power with cables or batteries and maintaining a large number of individual devices is complex and costly.

High overall costs as well as maintenance and management expenditure are barriers to wider use of building automation systems.

The installation costs for complete building automation system are therefore often not worthwhile for smaller residential units.

Building automation systems extending over a relatively large area or several floors suffer limitations due to the nature of the system in terms of range, since all the devices communicate via a central gateway or server and the distances involved are too great for some transmission standards. Battery-powered devices in particular frequently make use of extremely economical radio standards (e.g., Bluetooth LE) which has a highly limited range and consequent connection problems even in a detached house setting.

Known control devices or servers are conventionally housed in switchgear cabinets or mounting units which are then connected to sensors, switches, or actuators.

In order to reduce installation costs, many radio sensors are supplied with energy with (storage) batteries. Conversely, maintenance costs are higher in the long term.

Sensors and switches are, however, also installed in conventional commercial flush-mounting boxes or the devices are designed for wall mounting.

In Europe, flush-mounting boxes typically have an internal diameter of 60 mm and a depth of at least 40 mm.

Since 2018, 80-90% of new-build housing has been equipped with floor-, wall- or ceiling-mounted heating or air conditioning systems. This housing almost always has eye-level flush-mounting boxes with an integral power supply (AC or DC voltage) and optional data lines. Construction legislation in many EC countries specifies single-room control of heating systems.

Known control devices can already solve many different automation tasks, such as lighting and heating control, but they either do not fit in a single conventional commercial flush-mounting box or they require further external devices (servers, sensors, actuators).

Known stand-alone solutions are currently only available for specific applications (e.g., smart home thermostat).

A “typical” flush-mounting box for single-room control is located in the ideal zone (1.5 m height, centrally in the vicinity of the door in each room) for use to accommodate a compact smart home device.

A further major problem in the current prior art is a higher probability of failure in comparison with conventional control technologies and security concerns on the part of the end user.

### SUMMARY

It is an object of the disclosure to mitigate known disadvantages of the prior art and to reduce costs.

The object is achieved by the multipurpose multifunction device and by the method for implementing a distributed building automation network as described herein.

One particular advantage of the disclosure consists in the multipurpose nature of the multifunction device for implementing building automation applications, wherein the device has a housing and a display and comprises the following components:

at least one sensor, at least one actuator, at least one computing unit, at least one fan,

at least one loudspeaker and at least one microphone, wherein the components are arranged in the housing and thus combined in one device and the device is functional without a connection to a central gateway or network device. The building automation applications may here be of mutually differing kinds. This is intended to mean that heating/climate control is combined, for example, with lighting control, smart metering functions or an intercom system in one device. All current commercially available stand-alone smart home devices typically specialize on one control task (e.g., smart home thermostat).

The disclosure is a control device which has the aim of implementing all typical automation applications which recur on a room-by-room basis with a single device while dispensing with external sensors, user interfaces, gateways, actuators, servers, or control units.

Recurrent automation applications include, inter alia:
single-room control of heating, ventilation, climate control tasks,
lighting control,
roller blind control,
ambient lighting control,
presence detection, indoor positioning system,
presence simulation (break-in protection),
monitoring (surveillance system with integrated camera and display of external cameras),
noise/speech recognition,
smart metering, power measurement of connected consumers or room power consumption,
security/safety (alarm system, fire alarm, gas detector, moisture detector, window/door evaluation),
optical and acoustic alert system,
recording of sensor data for statistical, evaluation and evidential purposes, interactive display for entertainment purposes (digital picture frames), status display, and
internal communication, communication with outside (doorbell, intercom system).

The device according to the disclosure does not, however, predetermine the field of application, but is instead designed such that individual automation applications can also be provided by retrofitting expansion modules.

The device is to this end designed to receive expansion modules which are placed on the main board and are configured to be screwable to the housing through the main board, wherein electrical contact is established via spring pin contacts which are countersunk and soldered in the main board (spring pins are located in a THT hole and the solder collar is not located on the expansion module side, so enabling a contact point which has no structural height). At the contact point, the expansion modules have gold contact faces or conventional THT (through-hole-technology) holes. Examples of expansion modules:
modules for specific radio standards: ZigBee, Zwave, Enocean, LTE, 5G, HomeMatic sensor modules for voltage monitoring
multichannel gas sensors (e.g. MICS6814)
connection modules for specific wired networks, for example KNX.

The device is furthermore intended to be universally applicable. The computing units may be individually programmed such that any actions can be carried out in response to any sensor values, external data or user inputs.

The typical recurrent automation tasks require sensors, switches, and actuators which, in the prior art, entail a plurality of individual devices per room.

In order to reduce the installation costs of a smart home system, in the device according to the disclosure the necessary sensors, processing units (processors), power supply, I/O devices for user interaction, interfaces and actuators (relays, dimmers, thyristor controllers, triacs or the like), which are together in themselves capable of forming a complete multipurpose smart home-system, are integrated in one housing.

The multifunction device according to the disclosure is furthermore characterized in that the sensors are configured for temperature measurement and/or atmospheric humidity measurement and/or air pressure measurement and/or air quality measurement and/or motion detection and/or as a video camera and the actuators directly control electrical consumers and are configured as relays and/or dimmers and/or thyristors and/or triacs and/or control elements.

The device is fully functional without an external gateway or server.

Even if, in individual cases, a plurality of sensors are necessary (e.g., outdoor temperature sensor, gas consumption metering), the installation costs for a total-building automation system are greatly reduced when using the device according to the disclosure. Above all in small apartments and houses such as detached and duplex houses, installation costs are significantly reduced as a consequence. A wide range of control tasks can be carried out with just one individual device.

The device according to the disclosure is distinguished in that it is embodied as a drop-in replacement for a wall thermostat (used in the context of single-room control).

Its position ideally suits it to further room-related control tasks, such as air conditioning system control, roller blind control or lighting control. The device is simultaneously equipped with a touch-sensitive display in order to display current statuses and receive user input.

Due to its design, the device according to the disclosure can however also be installed in the box of a conventional commercial flush-mounting switch, socket outlet or the like.

It consists of at least two parts, wherein a cup-shaped convexity is shaped on the underside of the housing and is fixedly connectable to a conventional commercial flush-mounting box, wherein the housing has in its peripheral zone at least one ventilation opening or sensor opening as well as at least one opening in the upper part which is configured to receive a touch-sensitive display.

The device according to the disclosure is capable of actuating any desired electrical consumers and likewise network-compatible “smart” consumers. To this end, the device itself contains actuators (relays, dimmers, thyristors or similar) for driving heating control elements, motors, lamps, fans etc., interfaces (KNX, CAN bus, RS485, TTL, WLAN, Bluetooth, proprietary 433/868/915 MHz radio modules) for driving “smart” devices, actuators, switches, sensors or domestic appliances and conventional control outputs (analog output, PWM output, digital output).

The multifunction device furthermore has a memory unit for recording the sensor data and storing distributed control tasks and/or acoustic and optical signal generators or warning indicators and/or radio modules for communication and/or wired interfaces (KNX, CAN, RS485, TTL) and/or a fan, preferably configured as a speed-controlled blower, primarily for thermally decoupling the integrated sensors and cooling the device.

The device according to the disclosure takes a distributed approach. It carries out the local control tasks, insofar as possible, in the distributed, typically “room-by-room” subnetwork. It serves as a local server or gateway for “smart” devices in the “near” surroundings and is designed to link with similar devices according to the disclosure in other zones/rooms in order, for example, to carry out automation tasks extending beyond the individual room. This greatly reduces fault susceptibility of the room-by-room recurrent automation tasks since each room or section forms its own independent “smart home subnetwork” and failure of one subnetwork does not affect other subnetworks.

Bringing all the distributed devices according to the disclosure together on one server is possible and desired. It is conceivable for example to have a communication module in the operating system of the device according to the disclosure which separately communicates with a central server (e.g., KNX, Openhab, FHEM server). The “central server” may here also be a device according to the disclosure since the latter has the necessary components. In the event of failure of the declared “main server”, failover solutions which are already known in the art can be implemented.

Compressing numerous network components in the device according to the disclosure reduces the overall network load (bus load) and “radio load”, which improves the overall stability of the smart home network.

The devices according to the disclosure can be interconnected via various radio and wired interfaces (WLAN, Bluetooth, CAN bus, KNX bus, RS485, TTL/serial, proprietary radio link at 433/868/915 MHz). Range problems can be bypassed since each device according to the disclosure increases the range of the overall system (repeater function).

A connection to the outside world (internet, absent user) can be achieved via the integrated WLAN interface or optionally also LAN connection. Should no local internet access be available, a further development of the device may establish a direct connection to the internet or the end user via a GSM/2G/3G/LTE radio module.

In order to improve the acquisition of environmental data, such as temperature, atmospheric humidity or air quality, the device has a fan configured as an integrated active speed-controlled blower which, depending on the requirements profile, can supply the integrated sensors with a variable quantity of fresh ambient air. As a result, the sensors, for example gas sensors, respond more rapidly to changes in the surroundings and the sensors are better thermally decoupled from integrated self-heating components (processors, gas sensors with heaters, power supply unit).

At least one valve which is actively or vacuum-controlled may be integrated in a spatially separate zone within the housing. The spatially separate zone has a connection to the ambient air, wherein the valve opens toward the remainder of the housing interior (or a zone thereof) and thus enables a transfer of ambient air via the separate space into the remainder of the housing interior.

Customers' primary concerns about the use of building automation technology relate to fault tolerance and computer security in terms of protection against external attacks on the system.

The device according to the disclosure relies on open-source software in order to increase computer security or provide protection from hacking. Vulnerabilities and errors are more quickly uncovered in open-source software than in proprietary variants. Using open-source software also means the device can be more quickly integrated into individual automation applications.

At the same time, the device can consequently be integrated in many existing and even proprietary systems for which open software modules are available (e.g., Homematic, Somfy, etc.).

The further advantages of using open-source software will not be addressed here in greater detail.

In order to increase technical fault tolerance, the control unit in the device according to the disclosure is divided into a main computing unit and at least one further secondary computing unit.

The main computing unit is here distinguished in that it uses a multitasking operating system, has substantially greater computing power than a secondary computing unit and can provide more complex functions (graphical user interface, web server, evaluation of camera module data, etc.).

The secondary computing unit is distinguished in that it can have elementary control tasks transferred to it and it can also carry them out by itself if the main unit is out of service. Elementary control tasks are taken to be tasks which may arise locally and can be solved with the integrated sensors and actuators, for example single-room temperature control, light switches, CO alarm.

Suitable secondary units are 8, 16, and 32 bit microcontrollers which have a non-volatile memory for storing program code and data, for example AVR microcontrollers: Atmega32u4, AT90USB*, AT XMEGA or also 32 bit ATSAMD microcontrollers.

The secondary units are connected to the main computing unit via an internal network (e.g. I2C, USB, SPI etc.). The sensors can be polled by all the computing units via the bus system.

The main computing unit has mastery over the secondary units and is capable of modifying the program code of the secondary computing unit during ongoing operation. The secondary computing units may thus be adapted to all current circumstances and control tasks.

Higher overall stability can be achieved by the use of two separate systems in the device. The computing units can monitor one another and, in the event of failure, warn the end user or attempt to re-establish an operational state, for example by initiating a reset. To this end, the reset pins of the installed computing units are in each case connected to a GPIO pin of the other computing unit.

The integrated computing units are interconnected in such a way that they monitor one another and, in the event of failure of a computing unit, another computing unit is autonomously capable of warning the user acoustically, optically or via a network about the failure. Programs which complement the main processor may run on secondary programmable computing units. The integrated secondary computing units can be reprogrammed in ongoing operation by the main computing unit.

A separate power supply for the separate computing units can also be implemented in the device. In comparison with the main computing unit, the secondary computing units have a very much lower power consumption and may be separately supplied for example by a capacitor power supply unit.

The device according to the disclosure is of modular design and has a flexible range of functions. For instance, camera modules and microphones are accordingly not wanted in rooms with a greater need for privacy. The device can be adapted to meet the demands of these various situations.

The device according to the disclosure can also be variably equipped with different radio modules so that the device can purposefully be made compatible with specific radio systems (including proprietary radio systems).

The device consists of a subsurface part and an above-surface part, wherein the two components are firmly connected electrically via a pin header and mechanically via a plastic latching connector.

A power supply unit, the switching actuators and at least one ammeter are integrated in the subsurface zone of the device. The subsurface zone also provides an interface to supply, data and control lines.

Direct switching actuators are for example: relays, trailing-edge phase dimmers, leading-edge phase dimmers and thyristor controllers.

The device may alternatively be fitted with different subsurface components. Depending on the intended application, different actuators for controlling connected devices can be installed.

The housing may be shaped such that, without modification, it permits retrofitting of a camera module in a precisely fitting shaped portion in the housing upper part without requiring the removal of a light sensor installed in the same zone.

The housing may furthermore be shaped in the subsurface zone to receive a modular power supply unit with an electrical plug-in connection to the remainder of the control device. The device is equipped with a current sensor for measuring its self-consumption and/or the power consumption of at least one connected consumer.

The device is furthermore equipped in the subsurface zone with an LSA insulation displacement terminal for receiving data lines and/or with a thermally protected varistor in order to protect itself and consumers connected to the actuators from overvoltage.

The disclosure may therefore also be used in typical alternating current environments (110 v-240 V, 50/60 Hz) and direct current environments (island systems, 24 V heating systems, motor vehicles, boats 6 V-80 V, off-grid environments) by selection of the suitable power supply unit.

The separate subsurface zone also permits adaptation to required smart metering tasks.

AC power supply lines are typically arranged in ring circuits on a room-by-room basis.

The ammeter may therefore be used as a measuring device for the entire power consumption of the “ring” or for metering a device connected to an actuator.

The above-surface unit consists for example of:
a touch-sensitive display,
the sensors for detecting all room-dependent environmental values: light (brightness), temperature sensor, air pressure, atmospheric humidity, motion detector, IR sensors, gas sensors, (video) camera, microphone,
a main computing unit with open-source operating system,
at least one further secondary computing unit without operating system, typically 8-32 bit microcontroller,
a memory unit for recording sensor data and storing distributed control tasks,
acoustic and optical signal generators/warning indicators,
radio modules for communication,
wired interfaces (KNX, CAN, RS485, TTL), and
speed-controlled blower, primarily for thermally decoupling the integrated sensors and cooling the device.

A further advantage and component of the device according to the disclosure is a data output for connecting serially interconnected multicolor light sources with controllable color and brightness. The connected light sources in the “string” may here adopt different colors and brightness levels.

In this way, different color moods and lighting intensities can be created in different zones of a room.

The number of connected light sources is variable, such that differently sizes rooms can be illuminated. Typical light sources are RGB light-emitting diodes. In conjunction with the camera installed in the device, it is for example possible to analyze the image on a television located in the room and tailor the color mood in the room to it.

A further advantageous configuration of the device according to the disclosure is the integration of an infrared sensor (IR thermopile), hereinafter denoted IRS, which is integrated in the housing upper part and oriented so as to be able to detect the heat radiation in the center of the room. Measuring the IR radiation in the room promises advantages in terms of measuring the “perceived temperature” felt by people in the room and being able to control heating more precisely in line with requirements.

The multifunction device is equipped with a room-oriented infrared sensor for temperature detection with the aim of estimating the distance of a presence identified in the room by the motion detector on the basis of the temperature measured by the infrared sensor, wherein the infrared sensor is arranged such that it measures horizontally or virtually horizontally into the room in front of the device.

In combination with the integrated motion detector, it is also possible to predict the approach of a person to the device according to the disclosure.

The temperature difference determined between the internal temperature sensors and infrared sensor provides information about the proximity of a body which is warmer than the room because the infrared sensor is more strongly influenced by the proximity.

As a person approaches the device, the heat radiation from the person has a continuously stronger influence on the infrared sensor IRS.

The infrared sensor IRS may alternatively also be a thermal imaging camera.

Estimating approach allows the device to prepare for upcoming user inputs, for instance control elements which are normally grayed out can be faded in on the display screen in order to display the room data more clearly.

The method according to the disclosure for implementing a distributed building automation network, or smart home network, is constructed on the basis of a plurality of spatially “distributed” devices, wherein each distributed device functions as a connection interface for other “nearby” network-compatible smart home devices, sensors or actuators and thus establishes its own distributed network, wherein the various distributed devices form their own higher-level network while nevertheless remaining individually functional.

The disclosure will be explained in greater detail below on the basis of exemplary embodiments illustrated at least in part in the figures.

### BRIEF DESCRIPTION OF THE DRAWINGS

Further advantages and features of the disclosure are explained with reference to the following drawings, in which:

FIG. 1, is a view of the front panel of the device,

FIG. 2A is a view of the overall device with raised upper shell in order to represent airflow in the housing,

FIG. 2B is a view of the overall device without the board and display in order to represent airflow in the housing,

FIG. 3 is an exploded drawing of the device,

FIG. 4 is a representation of the device in typical installation positions in a room,

FIG. 5 is a representation of a functional overview/network diagram,

FIG. 6 is a representation of room temperature detection via infrared sensor,

FIG. 7 is a representation of trend-based measurement of the distance of the user from the device with the assistance of the motion detector and infrared sensor,

FIG. 8 is a representation of serially arranged multicolor ambient lighting connected to the device,

FIG. 9 is a front view of the housing,

FIG. 10 is a perspective representation of the housing upper part from below,

FIG. 11 is a side view of the entire housing from above,

FIG. 12 is a side view of the entire housing from below,

FIG. 13 is a side view of the entire housing from the left,

FIG. 14 is a side view of the entire housing from the right,

FIG. 15 is a detailed view of a housing zone for receiving the camera module,

FIG. 16 is an exemplary configuration of a valve of the internal sensor zone,

FIG. 17 is a bird's-eye view of an exemplary configuration of a valve, and

FIG. 18 is an expansion module receptacle in the housing.

### DETAILED DESCRIPTION

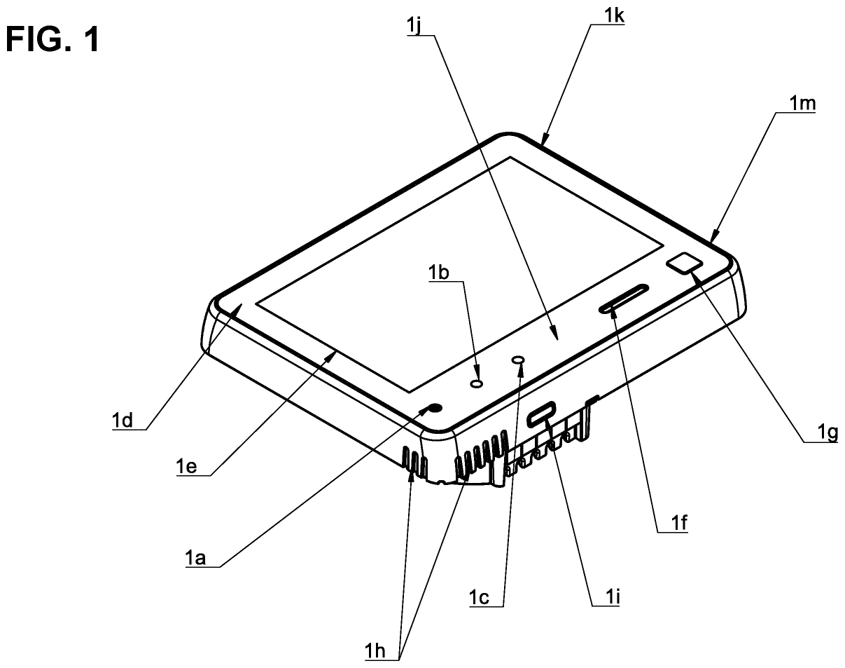

FIG. 1 shows one version of the device according to the disclosure. A full-surface touchscreen is set in the front panel of the housing. Elements 1a, 1b, 1c and 1g are sensors arranged horizontally in the housing which are oriented toward the zone in front of the device. They are here a light sensor/camera, infrared sensor/thermal imaging camera IRS and motion detector.

Element 1h forms the air inlet openings. The openings are arranged diagonally and enable an air stream through the sensor zone, even when the valve is closed. Sensors are arranged close to the air inlet opening.

Element 1k is a position for an air outlet opening with a blower located behind it.

Element 1d is a touchscreen in the housing color (touchscreen glass painted on the reverse side).

Element 1e is a transparent touchscreen zone for a graphical display.

Element 1i is an external USB port of the device.

Element 1m is a position of the data card slot arranged in the side of the housing and a combined opening for a reset switch and a microphone.

Element 1f is an opening in the front panel glass for a loudspeaker.

Element 1j is a position for a backlit logo.

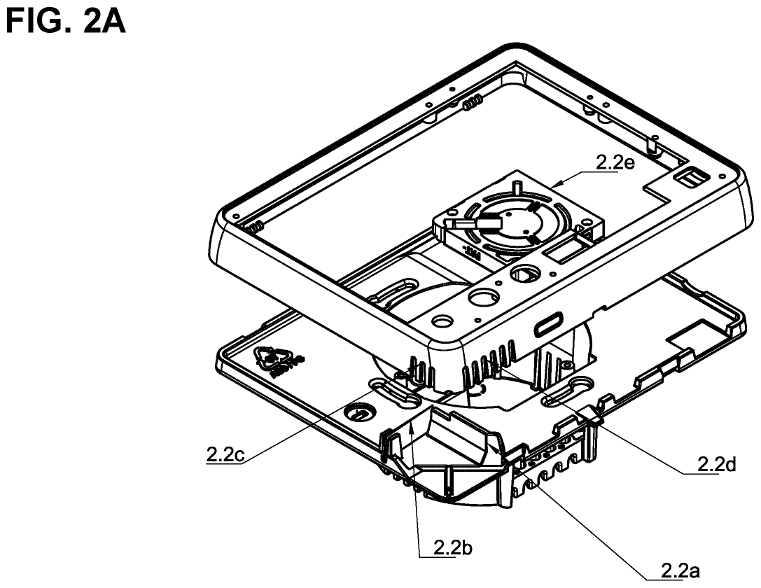

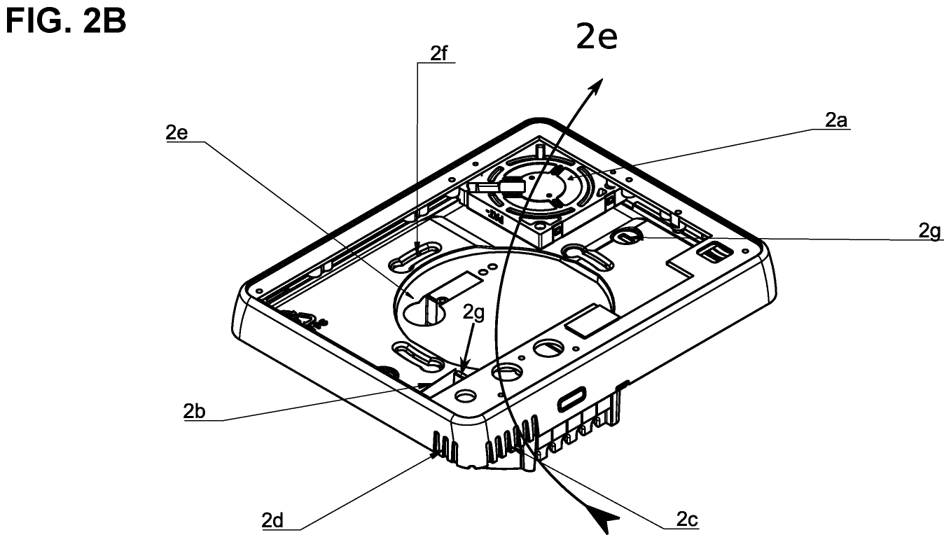

FIG. 2B shows the air stream 2e in the device, wherein the air stream forms between the main board and the lower housing part. When the blower 2a is active, the device draws in ambient air from the zones 2c and 2d and expels it at 2e. Due to the partition 2g shaped in the lower part, the sensor zone is separated from the remainder of the control device. The valve 2b opens due to the resultant vacuum when the blower 2a is active. A film 2e separates the power supply unit virtually air tightly from the upper part. The screw openings, for example indicated 2e and 2g, are supplied closed and the installer opens only the required openings in order to minimize any vacuum loss.

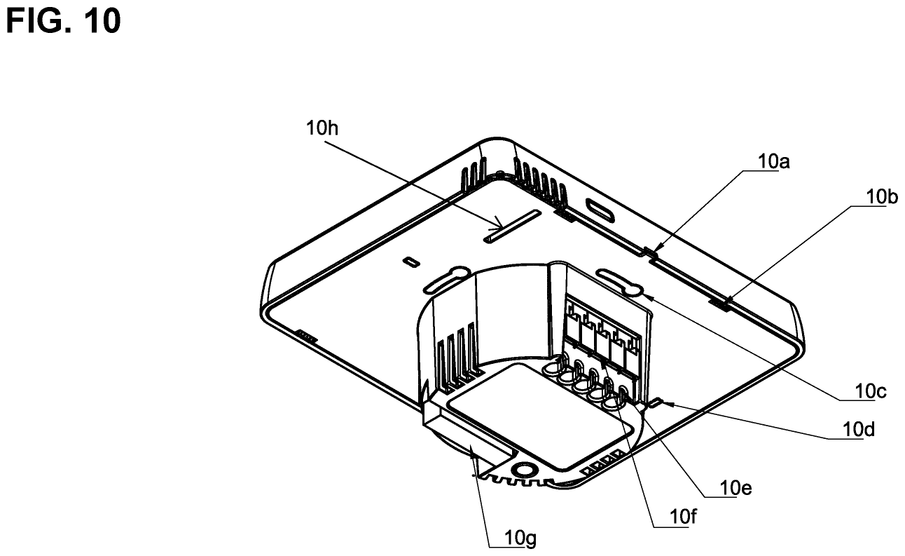

FIG. 2A shows the upper shell raised. Element 2.2a shows the isolated partition between the sensor zone and the remainder of the device. The partition is of a hollow configuration to improve insulation (see FIG. 10, reference sign 10h). Further, FIG. 2A shows:
valve membrane 2.2b,
blower 2.2e,
lower ventilation openings 2.2d, and
side ventilation openings 2.2c.

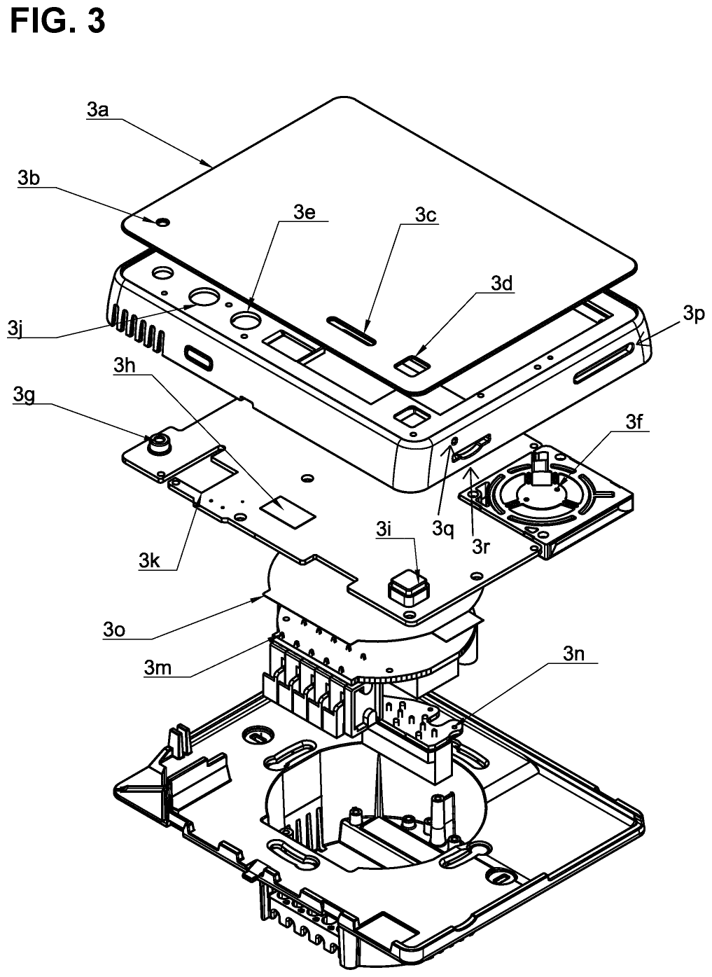

FIG. 3 shows the device according to the disclosure in exploded view. In particular,
3a shows the touchscreen glass surface,
3b shows the opening for the infrared heat sensor in the glass,
3c shows the opening for the loudspeaker,
3c shows the opening for the motion detector,
3e shows the cutout for the light sensor,
3f shows the speed-controllable blower,
3g shows the infrared sensor,
3h shows the RGB LED with light guide filter for logo in front panel glass,
3i shows the motion detector with plastic lens,
3j shows the cutout in the plastic for the camera lens,
3k shows the cutout in the board for the camera lens,
3m shows the power supply board with spring contacts,
3n shows the board for LSA terminal with connecting cable (cable not shown),
3o shows the insulating film for providing electrical insulation and an air seal to the upper part,
3p shows the side air outlet,
3q shows the opening for the reset switch and microphone, and
3r shows the opening for a micro-SD card.

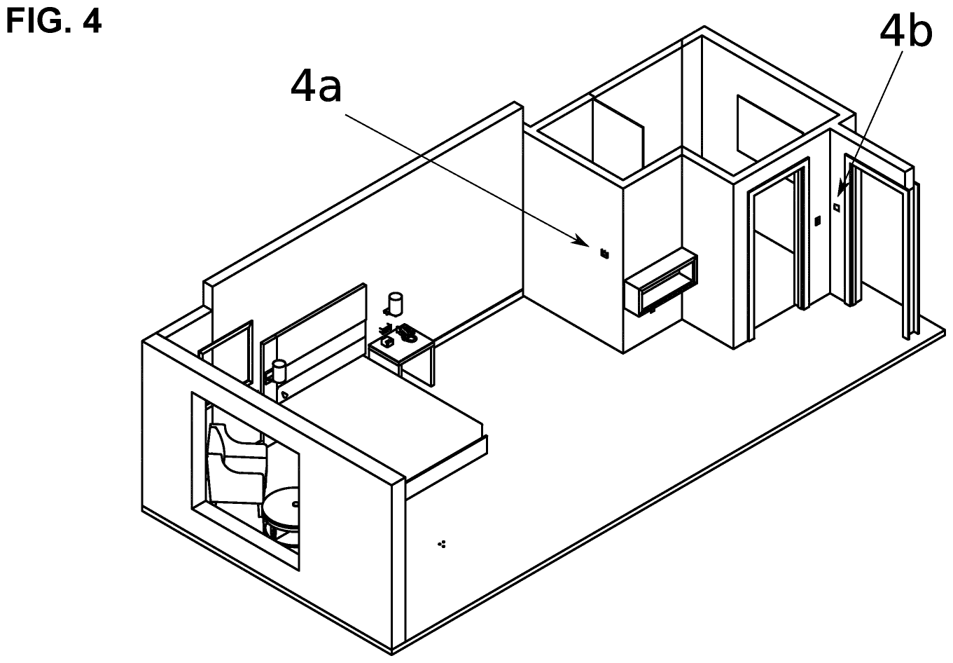

FIG. 4 shows the device according to the disclosure in typical installation positions 4a and 4b.

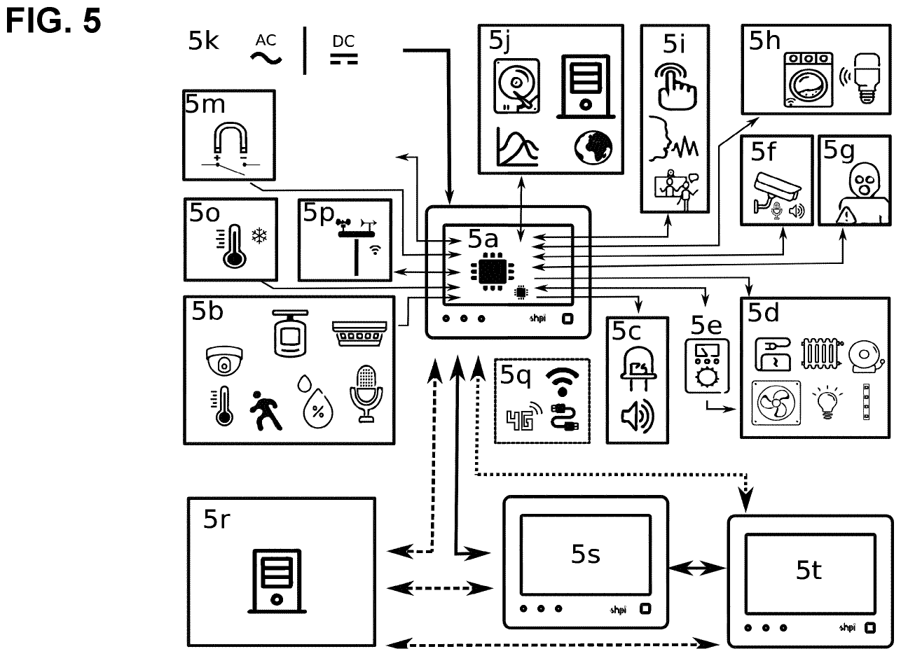

FIG. 5 contains a schematic function and connection overview of the device according to the disclosure in its operational environment.

Element 5a represents the device according to the disclosure with a main computing unit and secondary computing unit indicated by way of example.

Element 5k shows the external power supply: AC voltage or DC voltage.

Element 5b is a representation of the sensors integrated in the device itself. Motion, temperature, gas, atmospheric humidity, and pressure sensors, and optionally a microphone and camera are accordingly accommodated in the device. Presence detection or relative position determination is also possible via an integrated radio module which for example detects the signal level of a mobile telephone.

Element 5o represents external sensors without their own processing logic.

Element 5p shows “smart” sensors which enable communication in both directions.

Element 5m represents external switches or contacts (window contact, door contact, typically reed contact), without their own processing logic.

Element 5n represents “smart” switches with optional integrated actuators.

Element 5c shows actuators (signal LED, loudspeaker, piezo loudspeaker) integrated in the device according to the disclosure.

Element 5d shows typical electrical consumers which can be directly controlled with the actuators integrated in the device according to the disclosure.

Element 5e shows a power measurement module integrated in the device according to the disclosure for measuring consumption.

Element 5f shows the connection to an external camera. The connection may be bidirectional if the camera has a loudspeaker and microphone.

Element 5g separately represents monitoring or break-in detection Interactions (warning announcements) with detected burglars are conceivable.

Element 5h represents the connection to “smart” domestic appliances. These appliances may also provide sensor values under certain circumstances (e.g., washing machine reporting “laundry ready”)

Element 5i shows possible user interactions with the device. Touch inputs, speech inputs and communication with third parties via the device according to the disclosure are shown.

Element 5j is intended to represent internal gateway, server and processing functions. Each device according to the disclosure can record, process and evaluate data and make it available via the network.

Element 5r represents an optional external server via which the functions of the devices according to the disclosure can be centrally managed; integration into a KNX, OpenHAB or FHEM server is for example conceivable.

The connecting arrows between element 5a and further devices according to the disclosure elements 5s and 5t illustrate the flexible network topology. The devices may accordingly optionally log into a central radio network, but also connect to one another, act as repeaters and achieve range advantages.

Element 5q represents available interfaces of the device: near-field radio interfaces (WLAN, Bluetooth etc.), long-range radio links (2G, 3G, 4G, EDGE/UMTS/LTE) and wired systems (LAN, RS485, CAN etc.).

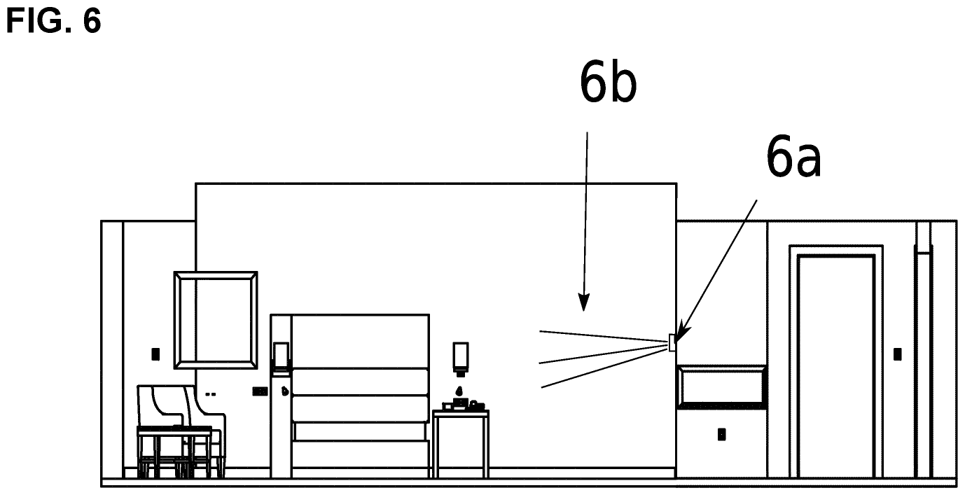

FIG. 6 shows the device according to the disclosure in a typical installation position 6a. The rays 6b represent the detection zone of the integrated infrared sensor IRS.

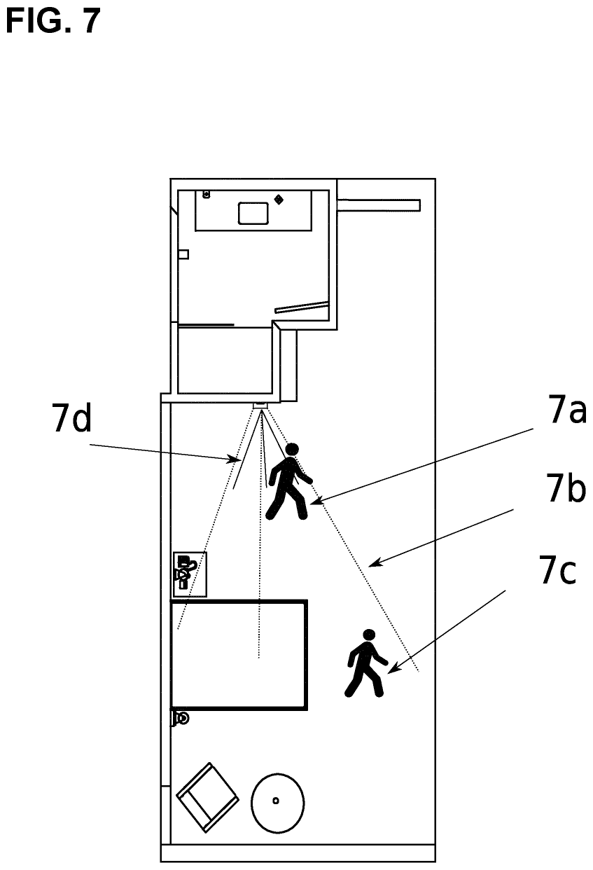

FIG. 7 represents the detection zone of the motion detector 7b by way of comparison with the detection zone of the infrared sensor IRS for temperature detection 7d. A person outside the detection zone of the infrared sensor IRS 7c has no influence on the temperature value detected by the infrared sensor IRS. On approaching the device according to the disclosure 7e, a person 7a has an increasingly strong influence on the sensor IRS. The determined temperature value becomes closer to the radiation temperature of the person 7a.

The system only functions under normal conditions. When room temperature is too high, the measurable temperature difference becomes smaller, such that the system cannot detect an approach.

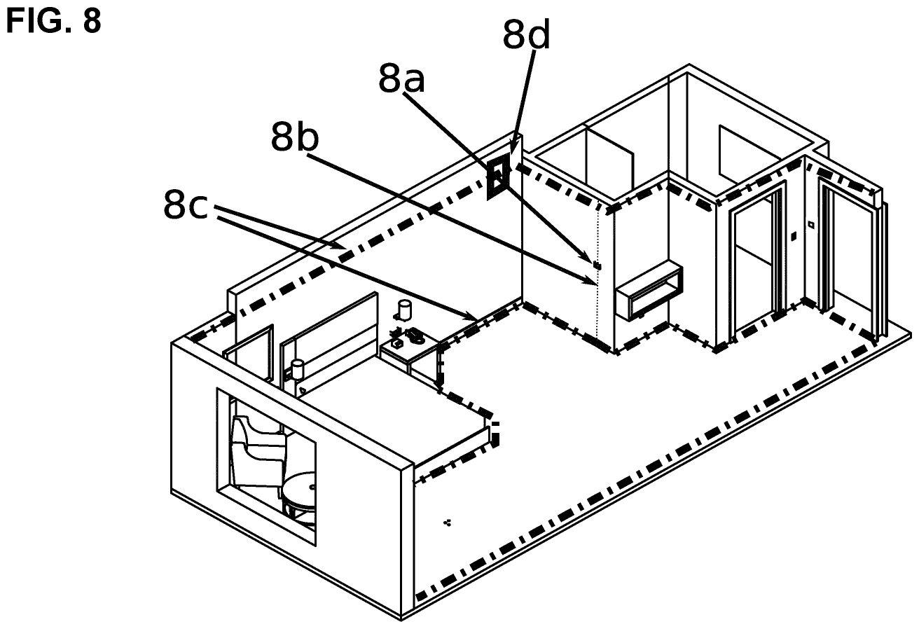

FIG. 8 shows the device according to the disclosure 8a with exemplary ambient lighting 8c in the ceiling and floor zones. Subsurface lines 8b connect the device to the ambient lighting 8c. Via a data line, the device according to the disclosure can separately control the brightness and color of each individual light source (dot in the lines 8c). In this way it is, for example, possible to create a lighting situation close to the bed which differs from that close to the entry door. Element 8d indicates an optional additional subsurface power supply unit if the necessary power requirement is higher than the capacity of the integrated power supply unit of the device according to the disclosure.

There is a problem of space for a multipurpose smart home system installable (alone) in a flush-mounting box because on the one hand sufficient space must remain in the lower zone of the box for connecting supply lines and the upper zone of the box must accommodate a power supply unit, while the control device likewise also requires space for cooling or ventilation thereof, in particular when typical smart home components (server, computing unit, sensors, actuators) are compressed in one device and differing automation tasks also have to be undertaken (heating/presence detection/lighting/monitoring).

At the same time, compressing all the components of a building automation system in one device results in increased self-heating which has a negative impact on the accuracy of the detected environmental data.

In known solutions, the housing of a control device is not suitable for receiving a complete building automation system which carries out a plurality of different automation tasks which also differ in kind and which can at the same time be a component of a higher-level distributed building automation system.

The present disclosure now also provides a housing of a control device which meets the above-stated requirements.

The housing according to the present disclosure consists of a rectangular housing upper part, which is mounted on the upper side of a plate of the housing lower part, wherein a cup-shaped convexity is shaped on the underside of the plate of the housing upper part.

The housing is advantageously uniformly configured for all the rooms of a building and fits in a conventional commercial flush-mounting box. It is suitable for a control device which enables different typical recurrent room-by-room automation applications, such as for example:
heating, ventilation and climate control tasks,
lighting control,
roller blind control,
ambient lighting control,
presence detection, indoor positioning system, presence simulation,
monitoring (surveillance system with integrated camera and display of external cameras),
noise/speech recognition,
smart metering, power measurement of connected consumers,
security/safety (alarm system, fire alarm, gas detector, moisture detector, window/door evaluation), and
optical and acoustic alert system.

The housing permits great variation in the functional range of the installed control device. In particular, the housing can be fitted with a light sensor and a camera module, wherein the housing is shaped such that, without modification, it permits retrofitting of a camera module in an accurately fitting shaped portion in the housing upper part without requiring removal of the light sensor. One and the same device can thus be used in rooms with a greater need for privacy and alternatively in public zones with greater security requirements.

The housing has a thermally decoupled, separate zone close to the air inlet, in which sensors are arranged in order to detect environmental data as accurately as possible and to reduce any impairment of sensor values due to self-heating by the control device. Partitions divide the sensors from heat sources (processor) in the device and form air guidance channels for optimized device cooling.

The housing according to the disclosure optionally additionally comprises a valve in the above-stated partitions close to the air inlet opening in order to minimize any impairment of the sensor values of the above-stated sensors due to self-heating of the control device.

The valve divides the above-stated isolated sensor zone from the remainder of the control device. Heat transfer (by convection or heat radiation) to the sensor zone is reduced as a consequence, so allowing more accurate environmental data to be measured. The valve opens due to the vacuum arising when the internal blower is active. The valve closes under the effect of gravity when the blower is deactivated.

The valve may for example consist of a flap, membrane or the like.

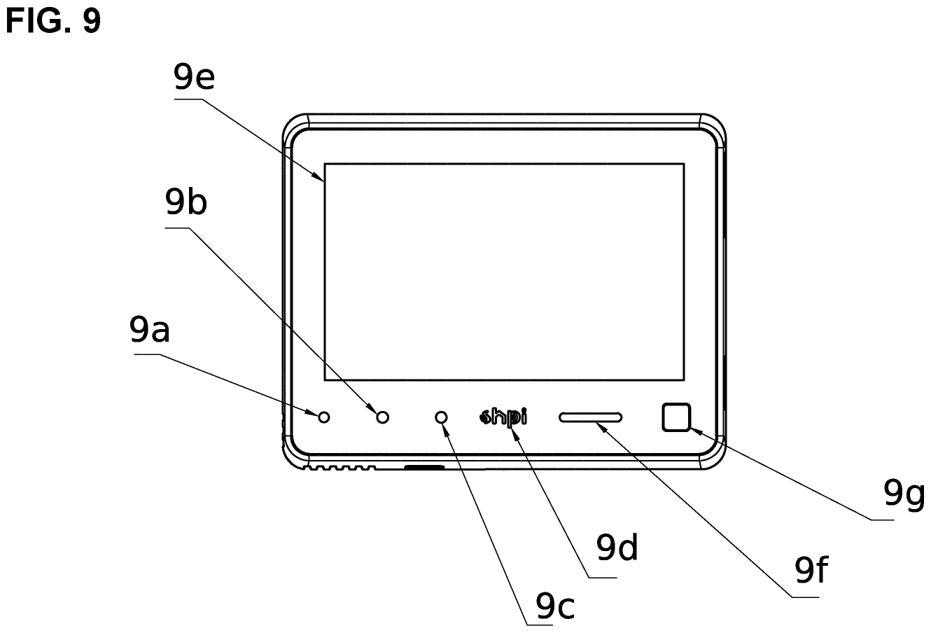

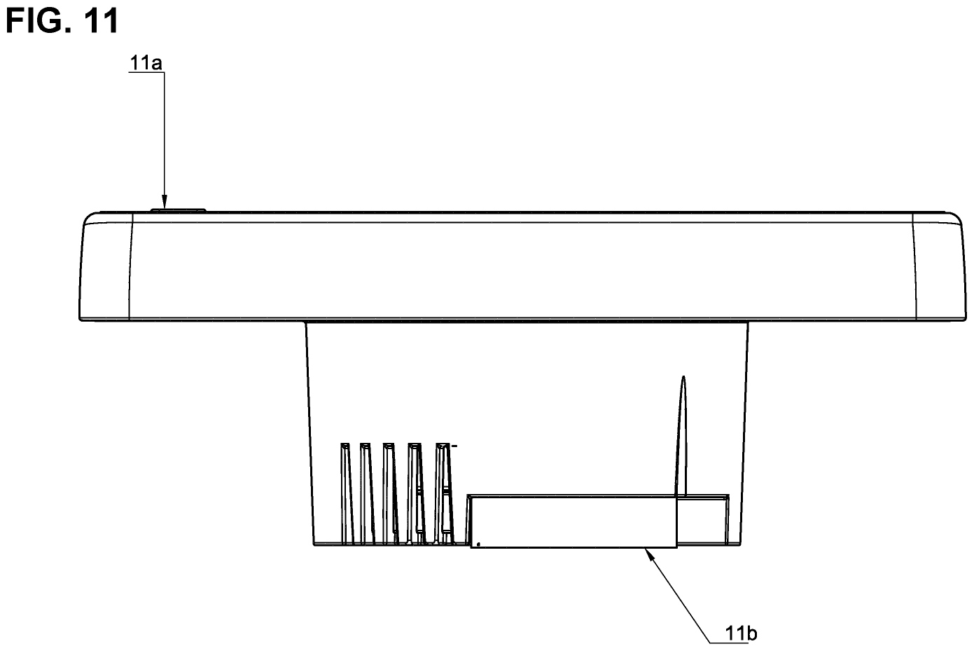

FIG. 9 shows a front view of the housing which has an upper part with a rectangular shape. A full-surface glass sheet with a touch-sensitive surface is set into the upper side. The housing upper part is configured to receive a board and for mounting of a housing lower part (see representation in FIG. 11). The openings 9a, 9b, and 9c are suitable for receiving a stills/video camera, light sensor, infrared temperature sensor, thermal imaging camera. Element 9d indicates the programmable color-backlit device logo. Element 9e represents the visible zone of the color display. Outside the visible zone, the glass front panel is colored the housing color. The cutout 9g serves as an opening for a motion detector. The opening 9f forms the sound outlet opening for the loudspeaker mounted behind it.

The perspective representation of the housing upper part according to FIG. 10 clarifies the opening 10a in the peripheral zone which permits external access for “undoing” the snap-fit latching connector 10b. Openings 10c for European or 86 mm UP boxes and American flush-mounting boxes 10d are incorporated in the underside. Element 10f indicates the spring contact terminal for electrically connecting the supply lines and consumers. The housing openings for the electrical cables are equipped with a taper 10e for clamping the electrical lines in place. An LSA terminal 10g is likewise incorporated in the subsurface zone. The partition of the sensor zone is of hollow configuration to improve insulation, as apparent from the label 10h.

FIGS. 11 to 14 all show side views of the housing, the housing upper part of which is mounted on the upper side of a plate of a housing lower part. A cup-shaped convexity is shaped on the underside of the plate of the housing lower part. The cup-shaped convexity of the housing lower part has an external diameter which is smaller than the internal diameter of a conventional commercial flush-mounting box. The height of the convexity of the housing lower part is less than the height of a conventional commercial flush-mounting box.

FIG. 11 is a side view from above. FIG. 11 shows:
motion detector 11a, and
LSA terminal 11b.

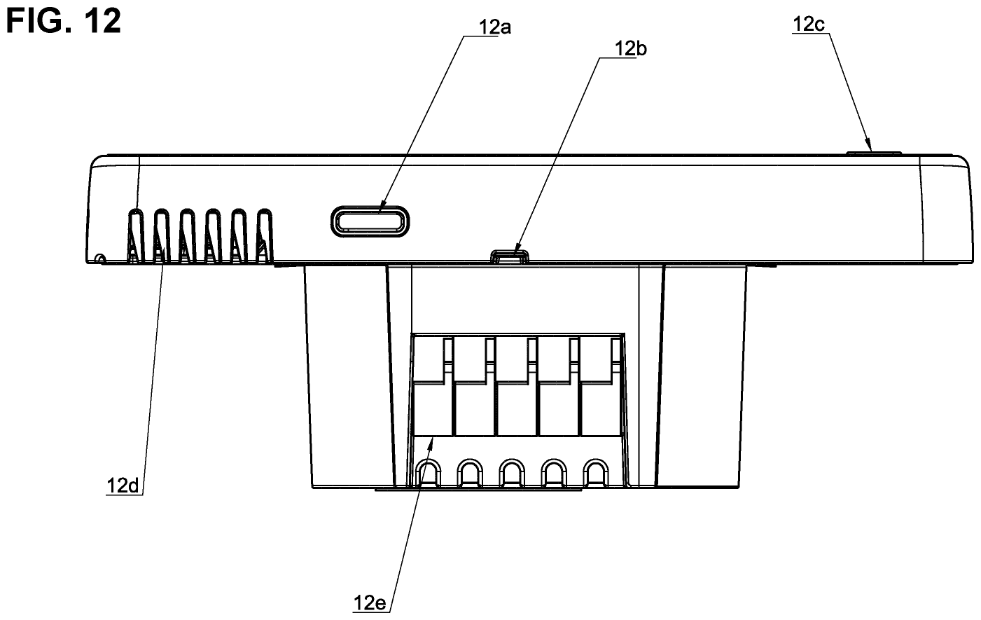

FIG. 12 is a side view from below. FIG. 12 shows:
opening 12a for USB-C connection,
opening aid 12b for unlocking snap-fit fastening,
motion detector 12c, and
diagonally arranged ventilation openings 12d.

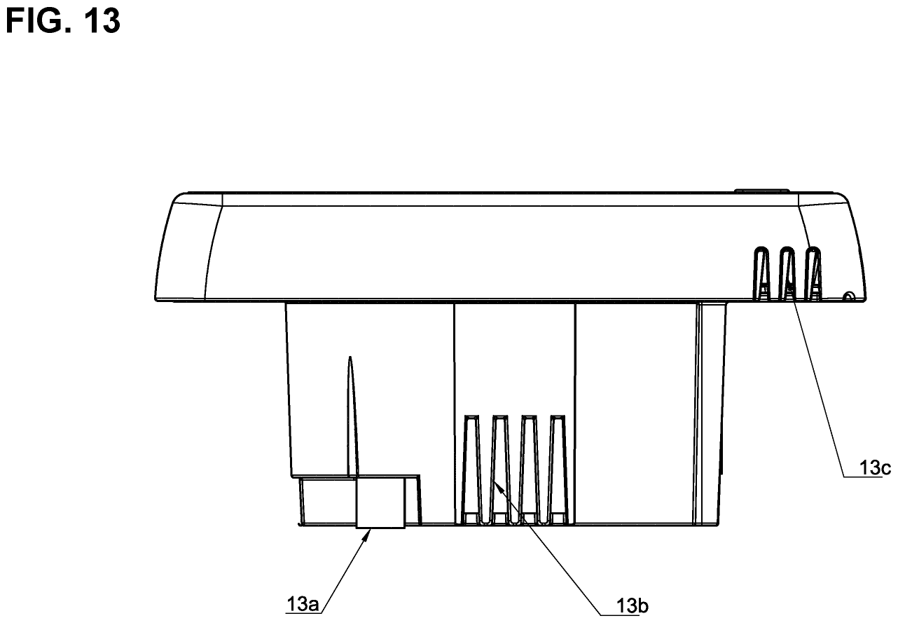

FIG. 13 is a side view from the left. FIG. 13 shows:
LSA terminal 13a,
side ventilation openings 13b for power supply unit, and
sensor zone 13c, diagonal ventilation openings.

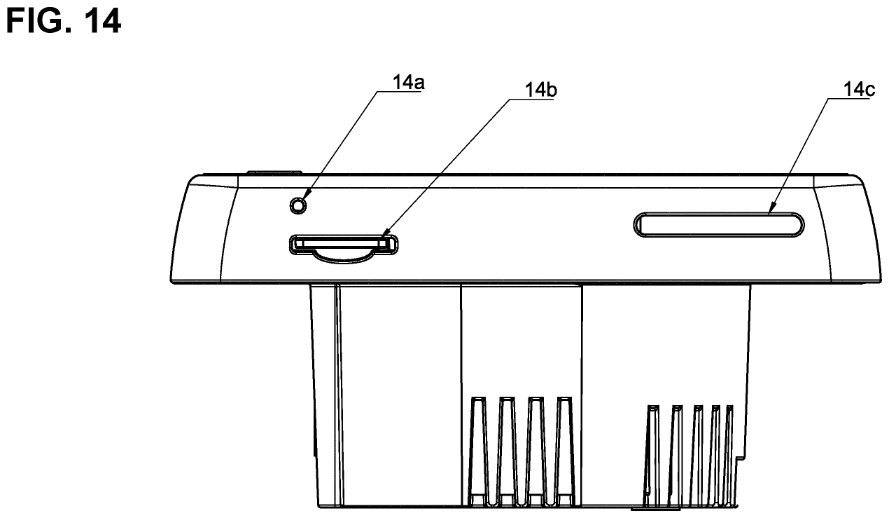

FIG. 14 is a side view from the right. FIG. 14 shows:
opening 14a for a reset switch and a microphone,
opening 14b for MicroSD card, and
air outlet 14c for a blower.

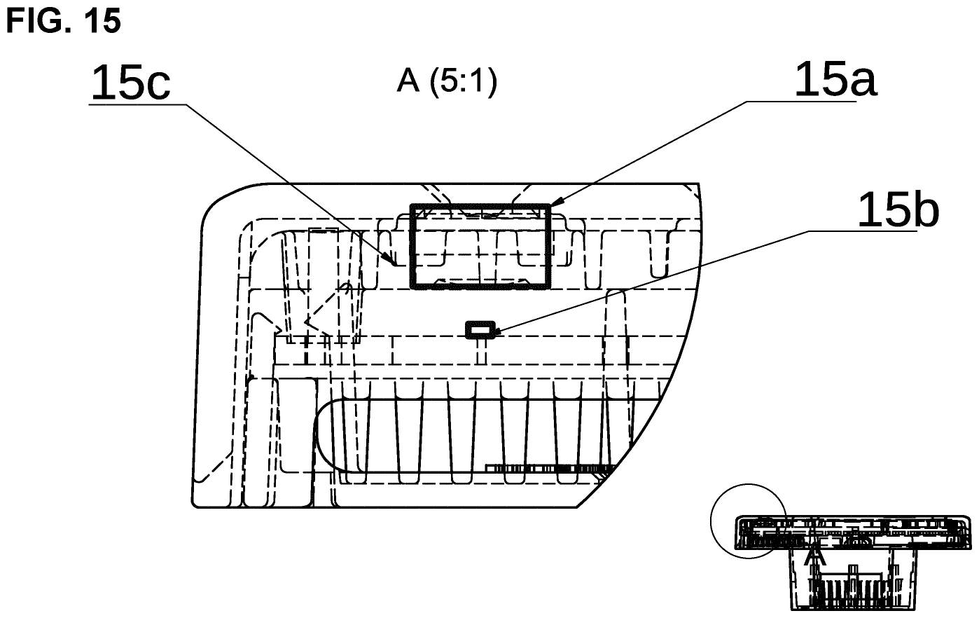

FIG. 15 shows the receiving position for the light sensor or LED and the camera module. The SMD component 15b soldered onto the board forms the fixedly installed light sensor. The shaped housing portion 15c can receive the polygonal camera module 15a or alternatively a round plastic lens.

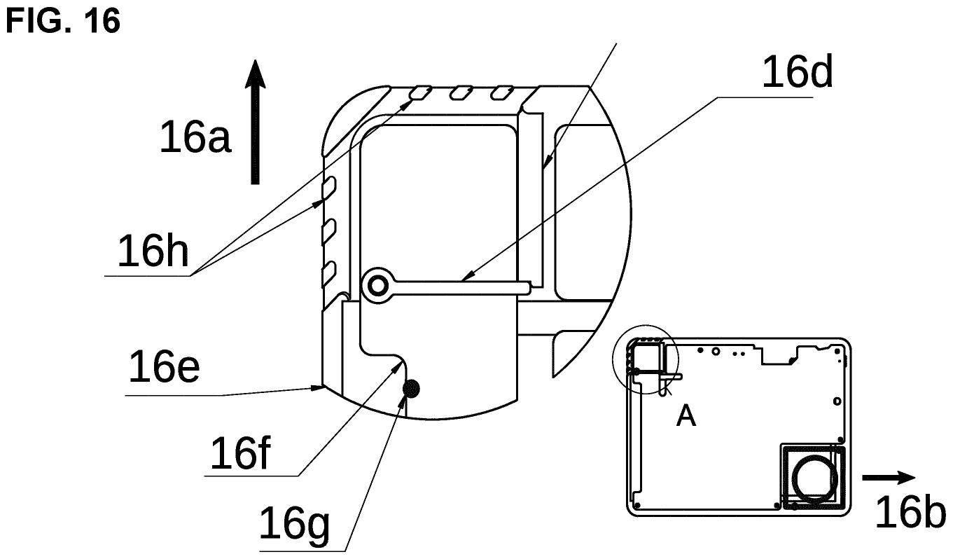

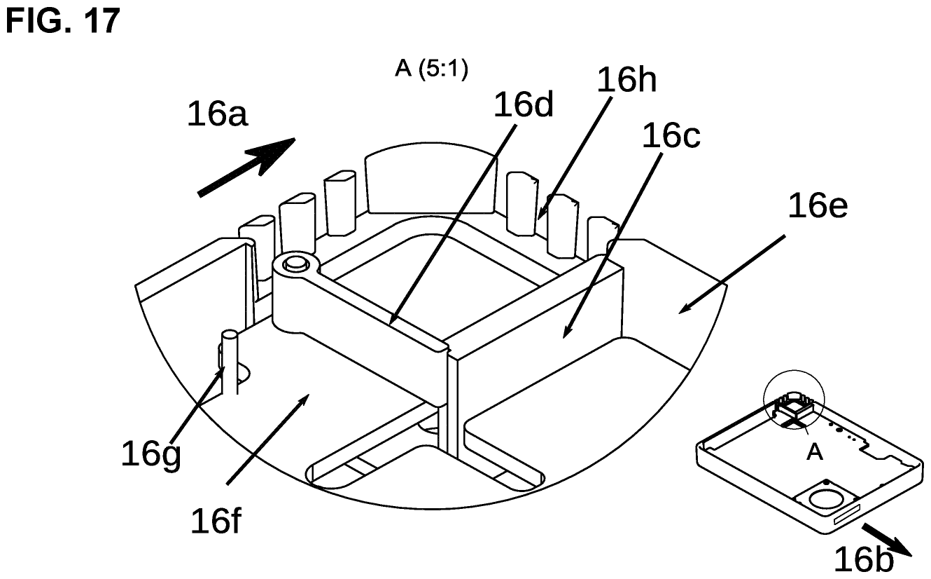

FIGS. 16 and 17 diagrammatically show a further development of the separate sensor zone with valve. The numbering in both drawings is identical. The sensor zone is shielded by a longitudinal cutout in the board 16f and by a partition 16c. The separate sensor zone has direct contact with the ambient air via the openings in the peripheral zone 16h in the housing upper part 16e. The valve flap 16d completely closes off the separate zone from the remainder of the control device. Under the effect of gravity, which acts in the direction of the arrow 16a, the flap remains closed in the normal state.

When the control device has an increased cooling requirement or there is another reason for ventilation, a blower generates an air stream in the direction 16b, and the resultant vacuum opens the flap/lever 16d.

The opened flap then enables a flow of an air stream through the entire housing.

The stop point 16g defines the movement radius such that the center of gravity of the valve flap 16d cannot be located beyond the axis of rotation and the effect of gravity 16a closes the flap again when the blower is switched off.

The valve flap 16d may also be embodied as a membrane (e.g., a flexible membrane fixed on one side).

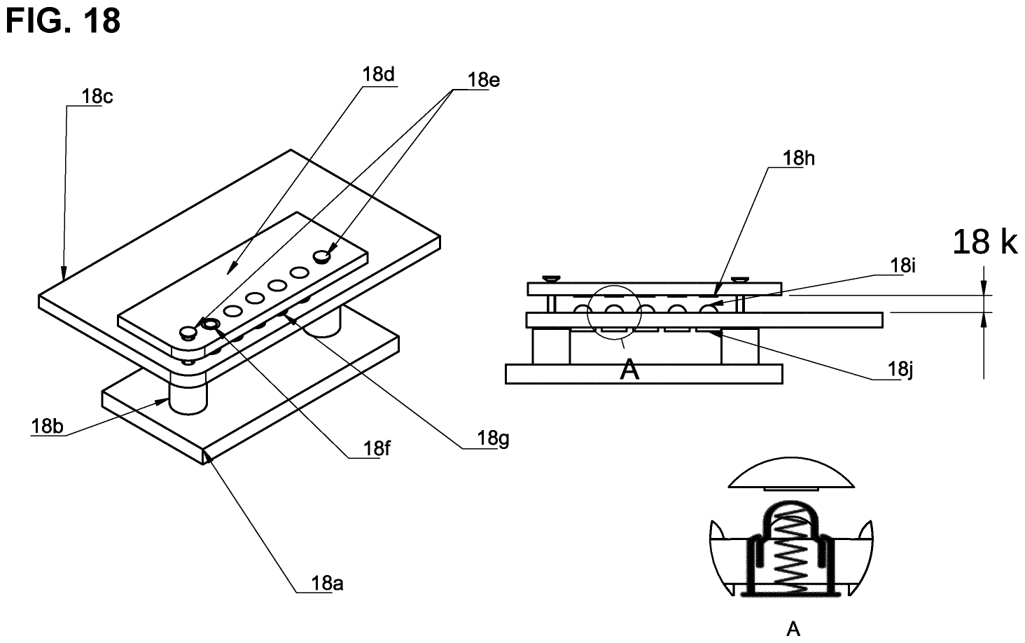

FIG. 18 shows an exemplary mounting of an expansion module in the device. The main board 18c is screwed with screws 18e to the housing upper part 18a via a plastic dome 18b.

A spring pin contact is by way of example soldered or pressed in place in the main board at position 18g. If the pin is soldered, it is soldered from the rear side. The collar 18j on the spring pin determines the correct position in the main board and simultaneously serves as a solder receiving surface. The spring pin head 18i is vertically freely mobile and a spring (detail drawing A) in the spring pin presses the head toward the expansion board 18d. By way of example, metallic contact points 18h or metallized THT holes (18f by way of example) are present in the expansion board. The pretensioning of the spring of the spring pin establishes a reliable electrical connection between the two boards. Due to the nature of the structure, the distance 18k between the boards is virtually 0. Countersinks are present in the main board below the expansion modules to allow expansion modules populated on both sides.

18a portion of front panel housing with screwed in main board 18b retaining dome with internal thread 18c main board 18d expansion board 18e mounting screws 18f exemplary THT hole 18g through-hole main board with spring contact pin soldered in place 18h gold contact face on expansion board 18i spring contact pin head 18j solder collar of spring contact pin 18k distance between main board and expansion module. Detail drawing A is a spring contact pin soldered in place and a head mobile.

It is understood that the foregoing description is that of the exemplary embodiments of the disclosure and that various changes and modifications may be made thereto without departing from the spirit and scope of the disclosure as defined in the appended claims.

1. A multipurpose multifunction device for implementing a plurality of building automation applications with a housing and a display and/or switches or pushbuttons, the multipurpose multifunction device comprising:
at least one sensor;
at least one actuator; and
at least one computing unit,
wherein the components are arranged in the housing and thus combined in one device and the device is functional without a connection to a central gateway or network device and the device is embodied for installation in a flush-mounting box or as a replacement device for a wall thermostat and has a power supply unit or voltage converter.

2. The multipurpose multifunction device according to claim 1, wherein the display is a touch-sensitive display and the sensors are configured for temperature measurement and/or atmospheric humidity measurement and/or air pressure measurement and/or air quality measurement and/or motion detection and/or as a video camera and the actuators directly control electrical consumers and are configured as relays and/or dimmers and/or thyristors and/or triacs and/or control elements.

3. The multipurpose multifunction device according to claim 1, wherein a memory unit for recording the sensor data and storing distributed control tasks and/or acoustic and optical signal generators or warning indicators and/or radio modules for communication and/or wired interfaces (KNX, CAN, RS485, TTL) and/or a fan, preferably configured as a speed-controlled blower, primarily for thermally decoupling the integrated sensors and cooling the device, is/are furthermore arranged.

4. The multipurpose multifunction device according to claim 1, wherein the multipurpose multifunction device is equipped with an intensity-controllable ventilation system (fan, blower) which is configured, depending on the utilization and self-heating of the device, to improve the thermal decoupling of the integrated sensors and to supply the latter more quickly with fresh ambient air to be measured.

5. The multipurpose multifunction device according to claim 1, wherein the housing consists of at least two parts,
wherein a cup-shaped convexity is shaped on the underside of the housing and is fixedly connectable to a conventional commercial flush-mounting box, and
wherein the housing has in its peripheral zone at least one ventilation opening or sensor opening as well as at least one opening in the upper part which is configured to receive a touch-sensitive display.

6. The multipurpose multifunction device according to claim 1, wherein the multipurpose multifunction device is equipped with a room-oriented infrared sensor for temperature detection, and/or is designed to estimate the distance of a presence in the room on the basis of the temperature measured by the infrared sensor, and
wherein the infrared sensor is arranged such that it measures horizontally or virtually horizontally into the room in front of the device and the device makes use of the motion detector or internal temperature sensors as a comparison value for calculating the distance of the presence.

7. The multipurpose multifunction device according to claim 1, wherein the integrated computing unit and sensors are interconnected in such a way that they monitor one another and, in the event of failure of a computing unit, another computing unit is autonomously capable of warning the user acoustically, optically or via a network about the failure,
wherein programs which complement the main processor run on secondary programmable computing units, and
wherein the integrated secondary computing units can be reprogrammed in ongoing operation by the main computing unit.

8. The multipurpose multifunction device according to claim 1, wherein at least one valve is integrated in a spatially separate zone within the housing, which valve is actively or vacuum-controlled and the spatially separate zone has a connection to the ambient air and the valve opens toward the remainder of the housing interior (or a zone thereof) and thus enables a transfer of ambient air via the separate space into the remainder of the housing interior.

9. The multipurpose multifunction device according to claim 1, wherein the multipurpose multifunction device is equipped with a loudspeaker and microphone and provides an intercom system and, if a video camera is installed, enables videotelephony.

10. The multipurpose multifunction device according to claim 1, wherein the multipurpose multifunction device is equipped with a data connection for serially interconnectable multicolor light sources and each LED can adopt another color state.

11. The multipurpose multifunction device according to claim 1, wherein the housing is shaped such that, without modification, the housing permits retrofitting of a camera module in a precisely fitting shaped portion in the housing upper part without requiring the removal of a light sensor or LED installed in the same zone.

12. The multipurpose multifunction device according to claim 1, wherein the housing is shaped in the subsurface zone to receive a modular power supply unit with an electrical plug-in connection to the remainder of the control device and the device is equipped with a current sensor for measuring its self-consumption and/or the power consumption of at least one connected consumer.

13. The multipurpose multifunction device according to claim 1, wherein the device is equipped in the subsurface zone with an LSA insulation displacement terminal for receiving data lines and/or in the subsurface zone with a thermally protected varistor in order to protect itself and consumers connected to the actuators from overvoltage.

14. The multipurpose multifunction device according to claim 1, wherein the multipurpose multifunction device is configured to receive expansion modules which are placed on the main board and are configured to be screwable to the housing through the main board, and
wherein electrical contact is established via spring pin contacts which are configured to be solderable in the main board from the rear side and, at the contact point, the expansion modules have gold contact faces or conventional THT (through-hole technology) vias.

15. A method for implementing a distributed building automation network, or smart home network, which is constructed on the basis of a plurality of spatially “distributed” devices,
wherein each distributed device functions as a connection interface for other “nearby” network-compatible smart home devices, sensors or actuators and thus establishes its own distributed network, and
wherein the various distributed devices form their own higher-level network while nevertheless remaining individually functional.
